(19) United States
(12) Patent Application Publication
(10) Pub. No.: US 2010/0048128 A1
(43) Pub. Date: Feb. 25, 2010

(54) COMMUNICATION METHOD BETWEEN COMPONENTS IN A WIRELESS SHORT HAUL NETWORK, AND NETWORK COMPONENT

(75) Inventors: Klaus Wendt, Sottrum (DE); Joachim Eisenhauer, Bremen (DE)

Correspondence Address: VENABLE LLP, P.O. BOX 34385, WASHINGTON, DC, 20043-9998, US

(73) Assignee: Rheinmetal Defence Electronics GmbH, Bremen (DE)

(21) Appl. No.: 12/440,560

(22) PCT Filed: Aug. 16, 2007
(86) PCT No.: PCT/EP07/07213

§ 371 Date: Sep. 2, 2009

(30) Foreign Application Priority Data
Sep. 9, 2006 (DE) 10 2006 042 432.8

(51) Int. Cl. H04B 7/00; G08B 1/08

(52) U.S. Cl. 455/41.2; 340/539.1

(57) ABSTRACT

Communication method between components in a wireless short haul network as part of a battlefield simulation, where one component is in the form of a master and the other components (AC1-AC10, SC1, SC2) are in the form of slaves, and—the slaves (AC1-AC10, SC1, SC2) transmit data synchronously or asynchronously to the master in an operating channel—synchronous slaves (SC1, SC2) send data in time windows (T1-T10) firmly associated with them and—asynchronous slaves (AC1-AC10) send data in event-based fashion.

The present invention relates to a communication method between components of a wireless short haul network, used in the context of a battlefield simulation, as well as to a network component for realizing this method.

As is known, duel simulator systems are used in combat-training centers for the firing training with directly aimed weapons. In the process, the data relating to the shooter, the fired shot, the type of weapon used and the ammunition used are transferred to the target with the aid of a directed and coded infrared laser beam. Several detectors are attached distributed to the participant representing a potential target, which detect the incident laser beam and are connected via cable to an electronic evaluation unit, the so-called participant unit that is carried by the participant, wherein the participant in this case can be a person or a vehicle.

The sensor spacing and the sensor position are selected in dependence on the diameter of the incident laser beam, such that it is possible to provide useful information concerning the point of incidence for the laser beam on the participant and thus also for the effect of the weapon in real combat. The participant unit is provided for this with an evaluation system that evaluates the hit on the basis of a stored vulnerability model. In addition, the participant unit also comprises a radio system which can establish radio contact with the central training office in order to report a hit.

The disadvantage of this type of system, known from prior art, is that the sensors or the cable connections are frequently damaged during the use in a military environment. In turn, this can result in a reduction of the functionality or a failure of the total sensor system and therefore of the participant during the training exercise.

To avoid damage to the cable connections, it has been proposed to connect the detectors to the participant unit via a radio link, such as a Bluetooth connection. However, the disadvantage of such a radio link via Bluetooth is the high energy requirement, which either greatly reduces the operating time for the sensor system or requires a correspondingly dimensioned storage battery that is heavy and difficult to handle.

It is therefore the object of the invention to provide a communication method for the communication between components of a wireless short haul network, used in the context of a battlefield simulation, which requires a low amount of energy, thus allowing the components to operate for a long period of time.

This object is solved according to the invention with a communication method as disclosed in claim 1. A network component for realizing this method is disclosed in claim 14. Advantageous embodiments are disclosed in the dependent patent claims.

With the method according to the invention for the communication between components of a wireless short haul network, used in the context of a battlefield simulation, one component is embodied as the master and the other components are embodied as the slaves. For this, the central participant unit preferably takes on the function of the master while the remaining components, such as the weapons or the detector units, represent the slaves. The slaves are provided with an unambiguous identification and transmit their data to the master via an operating channel, either synchronous or asynchronous. The data can relate, for example, to the information that a weapon was fired or that a detector unit was hit. Synchronous slaves transmit data during time slots that are fixedly assigned to them while asynchronous slaves transmit data in an event-based fashion. As a result, it is ensured that synchronous slaves, e.g. weapons, can transmit data to the master following a certain maximum reaction time. The synchronous communication furthermore permits the transmission of data from the master to a synchronous slave.

The master advantageously monitors the operating channel on a regular basis for a fixed period of time. Since the master is not continuously ready to receive, its energy requirement is reduced significantly, in particular with respect to the radio module and the signal processor.

It is extremely advantageous if the master monitors the operating channel at the start of the time windows for the synchronous slaves. A synchronous slave starts transmitting data within a fixed time interval, following the start of its time window. If the master could not detect a data transmission from the synchronous slave within this time interval, the master switches off its radio module for the time remaining in the time window and thus reduces its energy consumption. The master confirms receiving the data by sending out a message to that effect.

According to one embodiment of the invention, the synchronous slaves synchronize their time base to a radio beacon that is regularly emitted by the master, thereby ensuring that the time base of the master and the time bases of the synchronous slaves do not diverge past a critical measure. In addition to the time information, commands and/or other messages intended for one or several synchronous slaves are optionally also transmitted with the beacon. Special beacons can furthermore be emitted in addition to the regularly emitted beacons, for example if events occur.

In cases where data must be transmitted from the master to a synchronous slave, e.g. a command for deactivating a weapon, the availability of the data is signaled with the beacon. The addressed synchronous slave transmits during its time slot a message to the master which, once it is received, prompts the master to transmit the requested data to the synchronous slave. The synchronous slave then confirms receiving the data by transmitting another message to the master. This communication takes place via the operating channel.

Prior to transmitting data, the slaves preferably monitor the operating channel. A slave thus only transmits data if no activity has been detected in the monitored channel, which prevents a simultaneous transmission by two or more slaves and a collision in the operating channel. It is particularly advantageous if each slave waits for a period of time assigned to it before monitoring the operating channel. In particular, this applies to asynchronous slaves and is designed to prevent that two or more asynchronous slaves monitor and simultaneously transmit data via the operating channel during precisely the same time interval if one or several events occur at the same time.

If an event occurs, an asynchronous slave transmits requests to the master until the master responds to the request. An event of this type can, for example, refer to the detection of a hit. The asynchronous slave preferably transmits the requests via the operating channel. Prior to transmitting the initial request, the asynchronous slave first monitors the operating channel, as described in the above, in order to avoid collisions. Between the transmitting of requests, the asynchronous slave also monitors the operating channel and waits for the response from the master.

According to one embodiment of the invention, once the master receives a request from an asynchronous slave, the master sequentially prompts all asynchronous slaves to transmit data. If an asynchronous slave does not have data to be transmitted, for example because it was not hit, the slave will not react to the transmitting prompt from the master. Either the slave ignores the prompt from the master on purpose or it is in the sleeping mode for saving energy, so that it does not take notice of the prompt from the master.

The master advantageously confirms receiving data from a slave. If the slave does not receive a confirmation from the master, it will transmit the data again. A synchronous slave will transmit the data during the following time window assigned to it while an asynchronous slave again starts transmitting requests, thus starting the above-described procedure. According to a special embodiment of the invention, the message from the master to an asynchronous slave, confirming that the request was received, simultaneously also contains the transmitting prompt for the following asynchronous slave.

According to a different embodiment of the invention, a slave and in particular a synchronous slave regularly transmits an alive message to the master. As a result of this message, the master monitors the status and/or the presence of the slave.

The communication method according to the invention provides the option of connecting additional slaves into the network during the operation. For this, the master regularly monitors a channel for association, in which a slave to be associated, meaning a slave to be connected to the network, transmits requests until the master responds. It also applies to the channel for association that the components must first monitor the channel before they transmit data.

Following the response from the master, the slave transmits equipment information via the channel for association to the master. The equipment information includes, for example, the type and/or function of the slave, the serial number, the status, the usable codes, or the software revision. Following this, the master transmits network information to the slave to be associated and assigns an identification number to this slave. The network information relates, for example, to the identification of the participant and/or the network, the operating channel, or the codes used, wherein the codes used can be OSAG or MILES. The slave acknowledges the network information by transmitting an alive message.

A battlefield simulation generally involves several participants, which are each provided with a separate wireless short haul network. If possible, each network is assigned its own operating channel. However, if that is not possible because of limited number of frequencies, then several participants will share one operating channel. Each transmission via an operating channel contains an identification of the network, based on which the transmission can be assigned to a network. The channel for association is used jointly by all networks.

If the slave to be associated receives confirmations from several masters, then the network with maximum received capacity is preferably selected, which ensures that the master and the slave to be associated are located on the same participant.

This type of association is necessary, for example, if the participant picks up and prepares a new weapon, for example by removing the pin on a grenade, or if a sensor is added and/or replaced.

An initializing tool, for example an optical initializing tool, is used during the initial start-up of the network to provide the individual components attached to the participant with information concerning their position. Following this, the participants will regularly and for a brief period monitor the channel for association. By pushing a button, the master transmits requests via the channel for association, to which the slaves respond by providing their equipment information, which is then followed by the master transmitting the network information to the slaves. This mode of operation has the advantage that only the master selected by pushing the button transmits via the channel for association and that only the activated slaves will respond. The operational start-up of each network can thus be realized without problem, even with participants located closely adjacent to each other, by initializing the individual networks one after another.

For realizing the above-described communication method according to the invention, a network component is provided with a sensor and in particular an infrared (IR) sensor, a signal processor and a short haul radio module. With the aid of the sensor, signals are received and then evaluated by the signal processor. The signal processor determines whether a hit occurred and whether respective data are transmitted to the master via the short haul radio module, using the aforementioned method. The network component preferably can be switched to the sleep mode, from which it can be reactivated by a signal arriving at the sensor. In the sleep mode, for example, the short haul radio module or the signal processor is totally or partially deactivated to lower the energy requirement of the network component. The network component is fully activated only once a hit occurs.

According to a different embodiment of the invention, the network component is provided with a signal amplifier for amplifying the sensor signals. The signal amplifier increases the sensitivity of the network component, so that the energy of the signal transmitted by the weapon can be reduced.

The above-described communication method makes it possible to implement a short haul radio network with components having an extremely low energy requirement. Naturally, the detector units located on a participant are hit only very rarely, so that these will be in the sleep mode during almost the complete operating period. Even the energy requirement of the master is reduced since the master does not continuously monitor the operating channel and/or the channel for association.

The invention is to be explained in further detail with the aid of several exemplary embodiments, which show in:

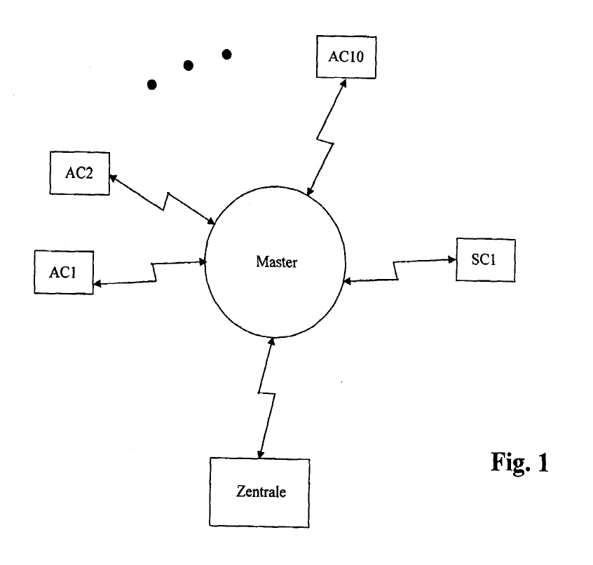

FIG. 1 A schematic configuration of a wireless short haul network;

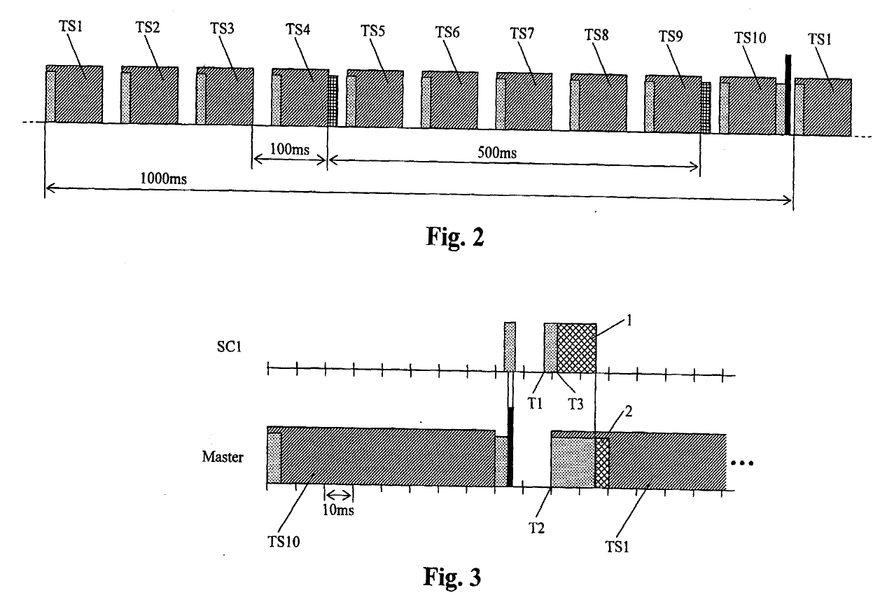

FIG. 2 The activities of the master plotted over time;

FIG. 3 The communication between the master and one synchronous slave;

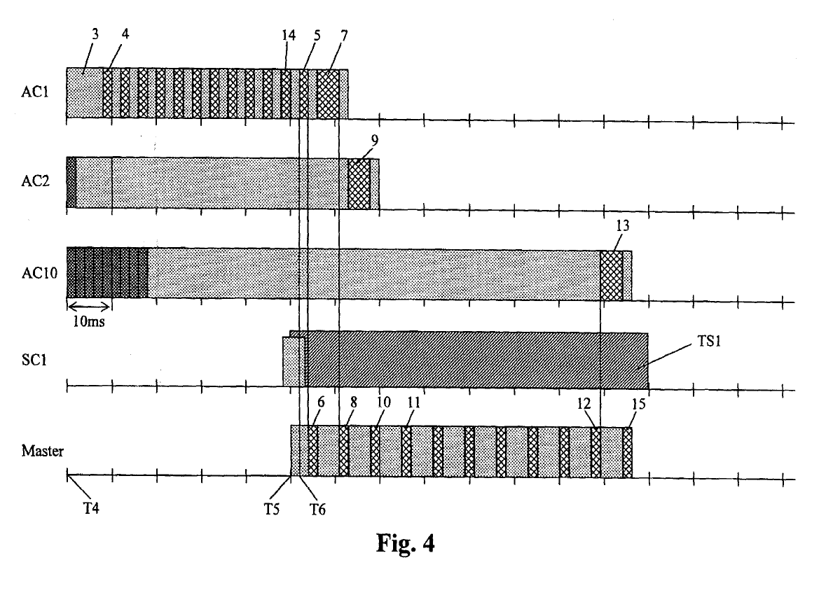

FIG. 4 The communication between the master and three asynchronous and one synchronous slave;

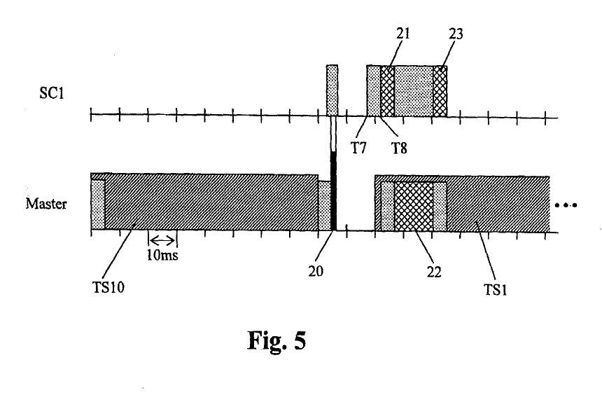

FIG. 5 The course of the communication during the data transmission from the master to a synchronous slave; and

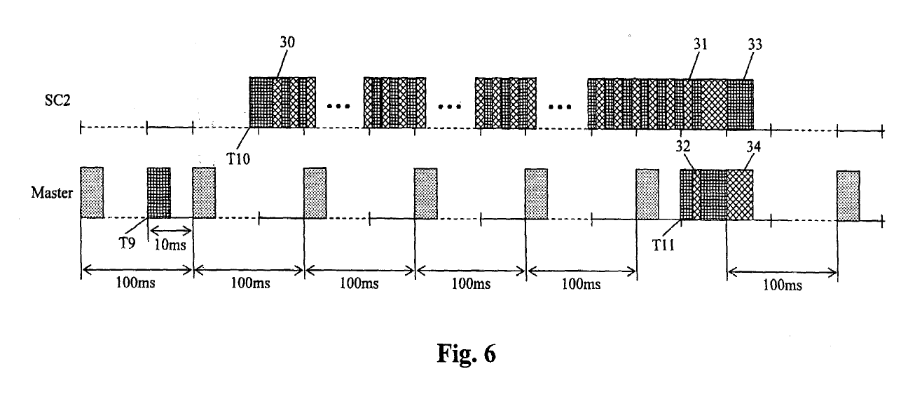

FIG. 6 The course of the communication during the association of a synchronous slave.

The following exemplary embodiment relates to a wireless short haul network that is operated, for example, with a baud rate of 38400 bits per second in an ISM (industrial, scientific, medical) band range at 868 MHz.

FIG. 1 schematically illustrates a wireless short haul network carried by a participant in a battlefield simulation. For the present example, the participant is a soldier carrying the master component of the network on the wrist, in the form of a display and operating unit. Ten infrared detectors are arranged distributed over the body of the soldier, wherein these detectors are connected as asynchronous slaves AC1-AC10 via radio link to the master. The soldier furthermore carries a weapon, which is connected wireless, as synchronous slave SC1, to the master. The master is connected via a long-haul radio link, for example TETRA (Terrestrial Trunked Radio), to a central unit that is in contact with a plurality of individual short haul networks.

The frequency range, available for the wireless short haul networks, is divided into one channel for association and one or several operating channels. If possible, each wireless short haul network uses a separate operating channel for the data transmission. The channel for association, which functions to connect new components into a network, is used jointly by all short haul networks.

When the weapon is fired, it emits a directed and coded infrared laser beam, wherein the coding contains information on the shooter, the shot fired, the type of weapon used, as well as the ammunition that is used. The weapon SC1 reports the firing to the master.

FIG. 2 shows the activities of the master plotted over time. For reasons of a better overview, the time intervals shown in FIG. 2 are not true to scale. The time axis is divided into ten time windows TS1 to TS10, which start every 100 milliseconds and respectively last for 80 milliseconds. The time windows repeat periodically every 1000 milliseconds and are shown with the aid of hatched lines. Each synchronous slave is assigned a time window for transmitting its data to the master. At the start of each time window, the master monitors the operating channel for a period of time, shown herein with dots and lasting 5 milliseconds, so as to determine whether a synchronous slave has started its data transmission. If no data transmission is detected, the master shuts off its radio receiver for the remaining time of the window to save energy.

At regular intervals, the master emits via the operating channel a beacon, indicated with a black line in FIG. 2, to which the synchronous slaves synchronize their time base. For the present example, a beacon lasting 2,083 milliseconds is transmitted every 5 seconds, thus ensuring that the master adheres to the maximum transmitting length of 0.1% within one hour, which is prescribed for the radio use in the ISM band range. Prior to emitting the beacon, the master briefly monitors the operating channel, in this case for 5 milliseconds, to prevent a collision of radio transmissions. Special beacons can furthermore also be transmitted if an event occurs, for example to prompt a slave to call up data.

Every 500 milliseconds, the master monitors the channel for association during a specified amount of time, here 5 milliseconds, as shown with the check pattern in FIG. 2 in order to detect radio activity from a network component to be associated. The associating of a component is described in further detail below, with the aid of FIG. 5.

FIG. 3 shows the activities of the master and the synchronous slave SC1 during the synchronous data transmission. The herein shown section of the time axis starts at the time slot TS10, in which the master monitors the operating channel for 5 milliseconds and subsequently shuts down its radio receiver to save energy because no radio activity is detected. The time slot TS1 that is assigned to the synchronous slave SC1 starts at point in time T2. At a point in time T1, the synchronous slave SC1 starts monitoring the operating channel to detect radio activities. Since no such radio activity can be detected, the synchronous slave SC1 starts transmitting its data 1 at point in time T3. The master then confirms having received the data by transmitting a corresponding message 2.

The point in time at which the synchronous slave SC1 starts monitoring the operating channel is selected such that the point in time T3 is within a specified time interval, here 5 milliseconds, following the start of the time window TS1. This is due to the fact that the synchronous slave SC1 cannot start transmitting its data until the start of the time slot TS1 assigned to it. On the other hand, the data transmission must start within a specified time interval, here 5 milliseconds, following the start of the time window TS1 since the master would otherwise shut down its radio receiver for the remaining time in the time window.

FIG. 3 also illustrates the emitting of a beacon by the master. Prior to emitting the beacon, the master monitors the operating channel to avoid collisions. The synchronous slave SC1 monitors the operating channel for the period, during which the emitting of the beacon is suspected, and synchronizes its time base to the clock of the master upon receiving the beacon. To compensate for time deviations between the master clock and the clock of the synchronous slave SC1, the slave monitors the operating channel for a period of time that exceeds the length of the beacon. If an expected beacon is not received, then a synchronous slave preferably expands the receiving period for a beacon during the following monitoring of the operating channel in order to compensate for increasing time deviations.

FIG. 4 shows the sequence of steps for the communication between three asynchronous slaves AC1, AC2 and AC10, as well as between the synchronous slave SC1 and the master. This communication is based on the exemplary scenario that the sensors of the asynchronous slaves AC1, AC2 and AC10 were hit by a laser beam at point in time T4 and that the weapon SC1 was fired.

Following detection of the hit at point in time T4, the asynchronous slave AC1 monitors the operating channel for a fixed period of time 3, lasting 8 milliseconds in this case, to determine radio activity and then starts transmitting a request 4 to the master, which lasts two milliseconds in this case. After transmitting the request 4, the asynchronous slave AC1 monitors the operating channel, in this case for two milliseconds. If no reply is received during this time from the master, the request is transmitted once more.

At point in time T5, at the start of the time slot TS1, the master monitors the operating channel and receives at point in time T6 the request 5 from the asynchronous slave AC1. Following this, the master transmits via the operating channel a transmitting prompt 6 that is directed to the asynchronous slave AC1. Following the prompt 6, the asynchronous slave AC1 transmits its data 7 via the operating channel to the master. Once it has received the data 7, the master transmits a message 8 to confirm that the data 7 were received and to prompt the asynchronous slave AC2 to transmit data. Based on this prompt, the asynchronous slave AC2 transmits its data 9 to the master, which in turn confirms receiving the data and sends a transmitting prompt to the asynchronous slave AC3. Since the asynchronous slave AC3 was not hit, it ignores the transmitting prompt 10 from the master. Once the time interval reserved for the data transmission from the asynchronous slave AC3 has passed, the master directs a transmitting prompt 11 to the asynchronous slave AC4. This operation continues until the master sends a transmitting prompt to the asynchronous slave AC10. Since this slave was hit, it responds to the transmitting prompt 12 from the master by transmitting the data 13. The master then acknowledges receiving these data by sending a message 15.

To prevent that with a simultaneous hit of the asynchronous slaves AC1, AC2, and AC10 at point in time T4, the slaves simultaneously start monitoring the operating channel and, following the monitoring, simultaneously start transmitting requests, thereby causing a collision on the radio interface, each asynchronous slave start monitoring the operating channel only after a waiting period assigned to it, which is shown check in FIG. 4. For the present exemplary embodiment, the asynchronous slave AC2 waits 2 milliseconds and the asynchronous slave AC10 waits eighteen milliseconds following the hit before monitoring the operating channel. Thus, the asynchronous slave AC2 determines two milliseconds before the end of the monitoring period that the asynchronous slave AC1 has transmitted the request 4 and thus stops the transmission of its own request. The same applies to the asynchronous slave AC10, but with a different delay time.

At the start of the time slot TS1 assigned to it, the synchronous slave SC1 starts monitoring the operating channel for radio activity. In the process, the synchronous slave SC1 determines that the asynchronous slave AC1 is transmitting a request 14 and therefore suppresses its own transmission of data until the following time slot assigned to it.

FIG. 5 shows the communication during the data transmission from the master to the synchronous slave SC1. With the beacon 20, the master signals the synchronous slave SC1 that data are ready to be called up. At point in time T7, shortly before the start of the time slot TS1 assigned to it, the synchronous slave SC1 begins monitoring the operating channel for radio activity. Since no activity can be detected, the synchronous slave SC1 transmits at point in time T8 a transmitting prompt 21 to the master. The master subsequently transmits the data 22 to the synchronous slave SC1, which then confirms receiving the data 22 by transmitting the message 23.

FIG. 6 illustrates the activities of the master and a synchronous slave SC2, which is to be accepted into the network. As is known from FIG. 2, the master briefly monitors the operating channel, here for 5 milliseconds, at the start of each time slot, every 100 milliseconds in this case, to detect slave transmissions, as shown with the dotted lines in FIG. 6. The master furthermore monitors every 500 milliseconds the channel for association for a period of 5 milliseconds, as shown with the check pattern. At a point in time T9, the master does not detect any activity in the channel for association. At point in time T10, the synchronous slave SC2 is to be accepted into the network. For this, it first monitors the channel for association for 5 milliseconds before transmitting a request 30, in this case lasting two milliseconds, to the master. The synchronous slave SC2 then waits for a specified time interval, also two milliseconds in this case, for a response from the master. If no response is received, the slave SC2 to be associated periodically transmits further requests and monitors the channel for association in-between the requests.

At point in time T11, the master again monitors the channel for association and, in the process, takes note of the request 31 from the slave SC2 to be associated. In response to the request, the master transmits a confirmation 32 via the channel for association. Following this confirmation 32, the synchronous slave SC2 transmits the equipment information 33 to the master. This equipment information 33 relates to the type of slave, its serial number, the status, the usable code, and the software revision. The master assigns an identification number to the slave SC2 to be associated and transmits network information 34 to the synchronous slave SC2. The network information 34 relates to the identification of the participant, the network identification, the operating channel, the local address for the new slave and the code that is used. As a result of the identification number, a time slot is automatically assigned to a synchronous slave. The identification number is also used with asynchronous slaves for controlling the communication process. For example, an asynchronous slave computes on the basis of its identification number the delay time required for waiting between the occurrence of a hit and the monitoring of the operating channel.

The above-described exemplary embodiment is only intended as an example and insofar is not limiting. In particular, this refers to the stated values for time intervals, which can be adapted optionally to the requirements of the network, for example to the number of participants, the frequency band, or the baud rate. The selection of the frequency and the moment for transmitting the beacon, as well as the monitoring of the channel for association, are furthermore left up to the person skilled in the art and implementing this method.

1. A communication method between components of a wireless short haul network, used in the context of a battlefield simulation, wherein one component is embodied as the master and the other components (AC1-AC10, SC1, SC2) are embodied as the slaves and wherein
the slaves (AC1-AC10, SC1, SC2) transmit data synchronously or asynchronously via an operating channel to the master;
synchronous slaves (SC1, SC2) transmit data in time windows (T1-T10) that are fixedly assigned to them; and
asynchronous slaves (AC1-AC10) transmit data in an event-based fashion.

2. The communication method according to claim 1, characterized in that the synchronous slaves (SC1, SC2) synchronize their time base to a beacon that is regularly emitted by the master.

3. The communication method according to claim 1, characterized in that the master regularly monitors the operating channel during a fixed time interval.

4. The communication method according to claim 3, characterized in that the master monitors the operating channel at the start of the time windows (T1-T10) for the synchronous slaves (SC1, SC2).

5. The communication method according to claim 1, characterized in that the slaves (AC1-AC10, SC1, SC2) monitor the operating channel before they transmit data.

6. The communication method according to claim 5, characterized in that each slave (AC1-AC10, SC1, SC2) waits for a time interval assigned to it before monitoring the operating channel.

7. The communication method according to claim 1, characterized in that if an event occurs, an asynchronous slave (AC1-AC10) transmits requests to the master until the master responds to the request.

8. The communication method according to claim 7, characterized in that after receiving a request from an asynchronous slave (AC1-AC10), the master sequentially prompts all asynchronous slaves (AC1-AC10) to transmit data.

9. The communication method according to claim 1, characterized in that the master confirms receiving the data from a slave (AC1-AC10, SC1, SC2).

10. The communication method according to claim 1, characterized in that the master regularly monitors a channel for association.

11. The communication method according to claim 10, characterized in that a slave (SC2) to be associated transmit requests via the channel for association to the master until the master responds.

12. The communication method according to claim 11, characterized in that following the response from the master, the slave (SC2) transmits equipment information to the master via the channel for association.

13. The communication method according to claim 12, characterized in that the master transmits network information and allocates an identification number to the slave (SC2) to be associated.

14. A network component (AC1-AC10, SC1, SC2) for realizing the communication method according to claim 1, said component comprising a sensor and in particular an IR sensor, a signal processor, and a short haul radio module.

15. The network component (AC1-AC10, SC1, SC2) according to claim 14, characterized in that the network component can be switched to a sleep mode from which it can be activated by a signal received by the sensor.

16. The network component (AC1-AC10, SC1, SC2) according to claim 1, characterized by a signal amplifier for amplifying the sensor signals.
